(19) United States
(12) Patent Application Publication
(10) Pub. No.: US 2024/0326332 A1
(43) Pub. Date: Oct. 3, 2024

(54) THREE-DIMENSIONAL SHAPING STAGE AND THREE-DIMENSIONAL SHAPING DEVICE

(71) Applicant: SEIKO EPSON CORPORATION, Tokyo (JP)

(72) Inventors: Takafumi SAMESHIMA, Shiojiri-shi (JP); Kazuhide NAKAMURA, Asahi-Mura (JP); Masayuki GOZU, Ina-shi (JP)

(21) Appl. No.: 18/616,307

(22) Filed: Mar. 26, 2024

(30) Foreign Application Priority Data
Mar. 28, 2023 (JP) 2023-051092

(51) Int. Cl. B29C 64/245; B29C 64/393; B33Y 30/00; B33Y 50/02

(52) U.S. Cl. CPC B29C 64/245; B29C 64/393; B33Y 30/00; B33Y 50/02

(57) ABSTRACT

A three-dimensional shaping stage includes: a placement portion having a reference surface whose flatness is adjusted; a shaping stage that has a shaping surface on which a shaping layer is stacked, a first side surface on which a recessed portion is formed, and a second side surface opposite to the first side surface, and that is placed on the reference surface; a pressing member including an engaging member engaging with the recessed portion and configured to press the shaping stage in a direction along the shaping surface; and a retaining member configured to retain the shaping stage on the second side surface.

The present application is based on, and claims priority from JP Application Serial Number 2023-051092, filed Mar. 28, 2023, the disclosure of which is hereby incorporated by reference herein in its entirety.

### BACKGROUND

### 1. Technical Field

The present disclosure relates to a three-dimensional shaping stage and a three-dimensional shaping device.

### 2. Related Art

There is known a three-dimensional shaping device that shapes a three-dimensional shaped object by dispensing a plasticized material toward a stage and curing the material.

For example, JP-A-2022-170965 describes a three-dimensional shaping device including a stage on which a shaping material is stacked, a nozzle that dispenses the shaping material toward a shaping region on the stage, and a heating unit that heats the shaping material stacked in the shaping region on the stage.

JP-A-2022-170965 is an example of the related art.

In the three-dimensional shaping device as described above, flatness of the stage, the heating unit, or the like is important.

### SUMMARY

A three-dimensional shaping stage according to an aspect of the present disclosure includes:
a placement portion having a reference surface whose flatness is adjusted;
a shaping stage that has a shaping surface on which a shaping layer is stacked, a first side surface on which a recessed portion is formed, and a second side surface opposite to the first side surface, and that is placed on the reference surface;
a pressing member including an engaging member engaging with the recessed portion and configured to press the shaping stage in a direction along the shaping surface; and
a retaining member configured to retain the shaping stage on the second side surface.

A three-dimensional shaping device according to an aspect the present disclosure includes:
the three-dimensional shaping stage according to the aspect; and
a nozzle configured to dispense a shaping material toward the three-dimensional shaping stage.

### BRIEF DESCRIPTION OF THE DRAWINGS

FIG. 1 is a perspective view schematically showing a three-dimensional shaping device according to an embodiment.

FIG. 2 is a cross-sectional view schematically showing the three-dimensional shaping device according to the embodiment.

FIG. 3 is a perspective view schematically showing a flat screw of the three-dimensional shaping device according to the embodiment.

FIG. 4 is a diagram schematically showing a barrel of the three-dimensional shaping device according to the embodiment.

FIG. 5 is a perspective view schematically showing a stage of the three-dimensional shaping device according to the embodiment.

FIG. 6 is a plan view schematically showing the stage of the three-dimensional shaping device according to the embodiment.

FIG. 7 is a perspective view schematically showing the stage of the three-dimensional shaping device according to the embodiment.

FIG. 8 is a flowchart showing an operation of the three-dimensional shaping device according to the embodiment.

FIG. 9 is a cross-sectional view showing a shaping layer forming processing of the three-dimensional shaping device according to the embodiment.

FIG. 10 is a perspective view schematically showing a stage of a three-dimensional shaping device according to a first modification of the embodiment.

FIG. 11 is a plan view schematically showing the stage of the three-dimensional shaping device according to the first modification of the embodiment.

FIG. 12 is a plan view schematically showing a heating unit, a sensor, and a shaping stage of the three-dimensional shaping device according to the first modification of the embodiment.

FIG. 13 is a plan view schematically showing the heating unit, the sensor, and the shaping stage of the three-dimensional shaping device according to the first modification of the embodiment.

FIG. 14 is a perspective view schematically showing a stage of a three-dimensional shaping device according to a second modification of the embodiment.

FIG. 15 is a cross-sectional view schematically showing the stage of the three-dimensional shaping device according to the second modification of the embodiment.

### DESCRIPTION OF EMBODIMENTS

Hereinafter, preferred embodiments of the present disclosure will be described in detail with reference to the drawings. The embodiments to be described below do not unduly limit contents of the present disclosure described in the claims. In addition, not all configurations to be described below are necessarily essential components of the present disclosure.

### 1. Three-Dimensional Shaping Device

### 1.1. Overall Configuration

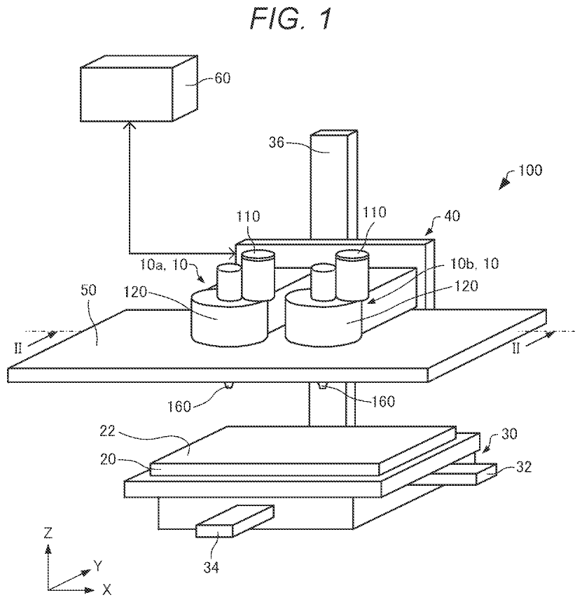

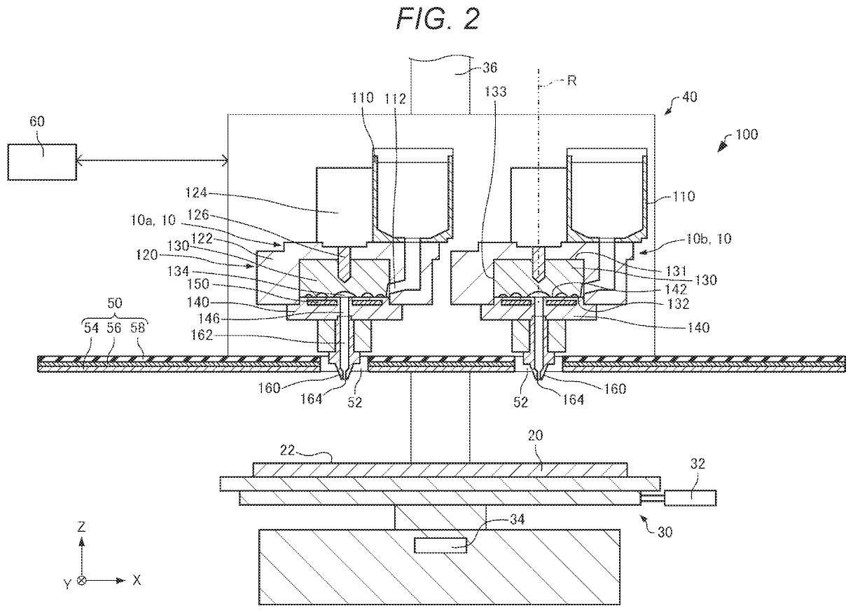

First, a three-dimensional shaping device according to the embodiment will be described with reference to the drawings. FIG. 1 is a perspective view schematically showing a three-dimensional shaping device 100 according to the embodiment. FIG. 2 is a cross-sectional view taken along a line II-II of FIG. 1 schematically showing the three-dimensional shaping device 100 according to the embodiment. In FIGS. 1 and 2, an X-axis, a Y-axis, and a Z-axis are shown as three axes orthogonal to one another. An X-axis direction and a Y-axis direction are, for example, horizontal directions. A Z-axis direction is, for example, a vertical direction.

As shown in FIGS. 1 and 2, the three-dimensional shaping device 100 includes, for example, dispensing units 10, a stage 20, a position changing unit 30, a support unit 40, a heating unit 50, and a control unit 60.

The three-dimensional shaping device 100 changes relative positions of the dispensing unit 10 and the stage 20 by driving the position changing unit 30 while dispensing a shaping material plasticized from the dispensing unit 10 toward the stage 20. Accordingly, the three-dimensional shaping device 100 shapes a three-dimensional shaped object having a desired shape on the stage 20. The three-dimensional shaping device 100 is a three-dimensional shaping device of fused deposition modeling (FDM) (registered trademark) type.

The three-dimensional shaping device 100 includes a first dispensing unit 10a and a second dispensing unit 10b as the dispensing unit 10. In the shown example, the first dispensing unit 10a and the second dispensing unit 10b are arranged in the X-axis direction. The first dispensing unit 10a and the second dispensing unit 10b have the same configuration, for example. Both the first dispensing unit 10a and the second dispensing unit 10b may dispense the shaping material constituting the three-dimensional shaped object, or one of the first dispensing unit 10a and the second dispensing unit 10b may dispense the shaping material and the other one may dispense a support material supporting the three-dimensional shaped object. Although not shown, one of the first dispensing unit 10a and the second dispensing unit 10b may not be provided.

The dispensing unit 10 includes, for example, a material storage unit 110, a plasticizing unit 120, and a nozzle 160.

The material storage unit 110 stores a pellet-shaped or powder-shaped material. The material storage unit 110 supplies the material to the plasticizing unit 120. The material storage unit 110 is implemented by, for example, a hopper. The material stored in the material storage unit 110 is, for example, an acrylonitrile butadiene styrene (ABS) resin.

As shown in FIG. 2, the material storage unit 110 and the plasticizing unit 120 are coupled by a supply path 112 provided below the material storage unit 110. The material charged into the material storage unit 110 is supplied to the plasticizing unit 120 through the supply path 112.

The plasticizing unit 120 includes, for example, a screw case 122, a drive motor 124, a flat screw 130, a barrel 140, and a heater 150. The plasticizing unit 120 plasticizes at least a part of the material in a solid state supplied from the material storage unit 110, generates a paste-shaped shaping material having fluidity, and supplies the shaping material to the nozzle 160.

The term “plasticize” is a concept including melting, and means changing from a solid state to a flowable state. Specifically, for a material in which glass transition occurs, the “plasticize” refers to setting a temperature of the material to be equal to or higher than a glass transition point. For a material in which the glass transition does not occur, the “plasticize” refers to setting the temperature of the material to be equal to or higher than a melting point.

The screw case 122 is a housing that houses the flat screw 130. The barrel 140 is provided on a lower surface of the screw case 122. The flat screw 130 is housed in a space surrounded by the screw case 122 and the barrel 140.

The drive motor 124 is provided on an upper surface of the screw case 122. The drive motor 124 is, for example, a servomotor. A shaft 126 of the drive motor 124 is coupled to an upper surface 131 of the flat screw 130. The drive motor 124 is controlled by the control unit 60. Although not shown, the shaft 126 of the drive motor 124 and the upper surface 131 of the flat screw 130 may be coupled via a speed reducer.

The flat screw 130 has a substantially cylindrical shape in which a size in a direction of a rotation axis R is smaller than a size in a direction orthogonal to the direction of the rotation axis R. In the shown example, the rotation axis R is parallel to the Z-axis. The flat screw 130 is rotated about the rotation axis R by a torque generated by the drive motor 124.

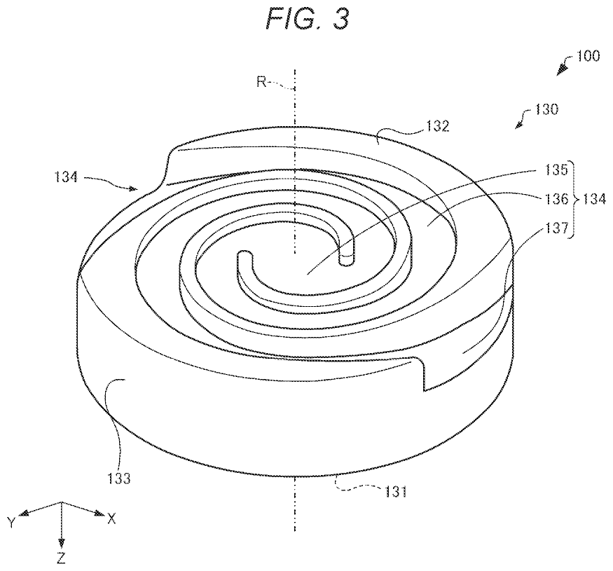

The flat screw 130 has the upper surface 131, a groove forming surface 132 opposite to the upper surface 131, and a side surface 133 coupling the upper surface 131 and the groove forming surface 132. A first groove 134 is formed in the groove forming surface 132. The side surface 133 is, for example, perpendicular to the groove forming surface 132. Here, FIG. 3 is a perspective view schematically showing the flat screw 130. For convenience, FIG. 3 shows a state in which an upper-lower positional relationship is reversed from a state shown in FIG. 2.

As shown in FIG. 3, the first groove 134 is formed in the groove forming surface 132 of the flat screw 130. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 and the material introduction portion 137. In the shown example, the coupling portion 136 is provided in a spiral shape from the central portion 135 toward an outer periphery of the groove forming surface 132. The material introduction portion 137 is provided on the outer periphery of the groove forming surface 132. That is, the material introduction portion 137 is provided on the side surface 133 of the flat screw 130. The material supplied from the material storage unit 110 is introduced from the material introduction portion 137 into the first groove 134, passes through the coupling portion 136 and the central portion 135, and is conveyed to the communication hole 146 formed in the barrel 140. For example, two first grooves 134 are provided.

The number of the first grooves 134 is not particularly limited. Although not shown, three or more first grooves 134 may be formed, or only one first groove 134 may be formed.

Although not shown, the plasticizing unit 120 may include an elongated in-line screw having a spiral groove on a side surface thereof, instead of the flat screw 130. The plasticizing unit 120 may plasticize the material by rotation of the in-line screw.

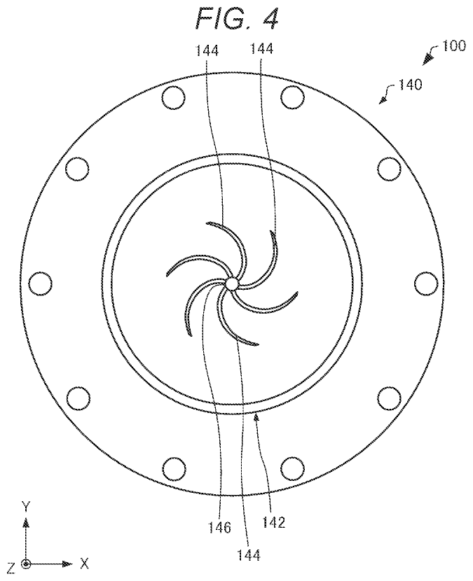

As shown in FIG. 2, the barrel 140 is provided below the flat screw 130. The barrel 140 has a facing surface 142 facing the groove forming surface 132 of the flat screw 130. The communication hole 146 communicating with the first groove 134 is formed in a center of the facing surface 142. Here, FIG. 4 is a plan view schematically showing the barrel 140.

As shown in FIG. 4, a second groove 144 and the communication hole 146 are formed in the facing surface 142 of the barrel 140. A plurality of the second grooves 144 are formed. In the shown example, six second grooves 144 are formed, and the number of the second grooves 144 is not particularly limited. The plurality of second grooves 144 are formed around the communication hole 146 when viewed from the Z-axis direction. One ends of the second grooves 144 are coupled to the communication hole 146, and the second grooves 144 extend spirally from the communication hole 146 toward an outer periphery of the barrel 140. The second grooves 144 have a function of guiding the plasticized shaping material to the communication hole 146.

A shape of the second groove 144 is not particularly limited, and may be, for example, a linear shape. The one end of the second groove 144 may not be coupled to the communication hole 146. Further, the second groove 144 may not be formed in the facing surface 142. However, in consideration of efficiently guiding the plasticized material to the communication hole 146, the second groove 144 is preferably formed in the facing surface 142.

As shown in FIG. 2, the heater 150 is provided in the barrel 140. The heater 150 heats the material supplied between the flat screw 130 and the barrel 140. An output of the heater 150 is controlled by the control unit 60. The plasticizing unit 120 heats the material while conveying the material toward the communication hole 146 by the flat screw 130, the barrel 140, and the heater 150 to generate the plasticized shaping material. Then, the plasticizing unit 120 causes the generated shaping material to flow out from the communication hole 146.

When viewed from the Z-axis direction, the heater 150 may have a ring shape. The heater 150 may be provided below the barrel 140 instead of in the barrel 140.

The nozzle 160 is provided below the barrel 140. A nozzle flow path 162 is formed in the nozzle 160. The nozzle flow path 162 communicates with the communication hole 146. The shaping material is supplied to the nozzle flow path 162 from the communication hole 146. A nozzle opening 164 communicating with the nozzle flow path 162 is formed at a tip end of the nozzle 160. In the shown example, the nozzle opening 164 is formed at an end of the nozzle 160 in the −Z-axis direction. The nozzle 160 dispenses, toward the stage 20, the shaping material supplied to the nozzle flow path 162 from the nozzle opening 164.

As shown in FIGS. 1 and 2, the stage 20 is provided below the nozzle 160. The stage 20 has a shaping surface 22 on which shaping layers made of a shaping material are stacked. The shaping surface 22 is an upper surface of the stage 20. For convenience, in FIGS. 1 and 2, the stage 20 is shown in a simplified manner. A detailed configuration of the stage 20 will be described later.

The position changing unit 30 supports the stage 20. The position changing unit 30 changes relative positions of the dispensing unit 10 and the stage 20. In the shown example, the position changing unit 30 changes relative positions of the nozzle 160 and the stage 20 in the X-axis direction and the Y-axis direction by moving the stage 20 in the X-axis direction and the Y-axis direction. Further, the position changing unit 30 changes the relative positions of the nozzle 160 and the stage 20 in the Z-axis direction by moving the dispensing unit 10 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the dispensing unit 10 in the Z-axis direction.

A configuration of the position changing unit 30 is not particularly limited as long as the relative positions of the dispensing unit 10 and the stage 20 can be changed. For example, the position changing unit 30 may move the stage 20 in the Z-axis direction and move the dispensing unit 10 in the X-axis direction and the Y-axis direction. The position changing unit 30 may move the stage 20 or the dispensing unit 10 in the X-axis direction, the Y-axis direction, and the Z-axis direction.

The support unit 40 is coupled to the third electric actuator 36. The support unit 40 supports the dispensing unit 10. The position changing unit 30 moves the dispensing unit 10 in the Z-axis direction by moving the support unit 40 in the Z-axis direction by the third electric actuator 36.

The heating unit 50 is provided above the stage 20. The heating unit 50 is supported by the support unit 40. Although not shown, the support unit 40 may include a pair of support bowls extending in the Y-axis direction, and the heating unit 50 may be suspended and supported by the pair of support bowls. The heating unit 50 is moved in conjunction with the dispensing unit 10 by the position changing unit 30. A shape of the heating unit 50 is, for example, a plate shape. The heating unit 50 overlaps the shaping surface 22 when viewed from the Z-axis direction.

As shown in FIG. 2, a through hole 52 is formed in the heating unit 50. The through hole 52 penetrates the heating unit 50 in the Z-axis direction. When the three-dimensional shaped object is shaped, the nozzle 160 of the dispensing unit 10 is positioned in the through hole 52. When the three-dimensional shaped object is shaped, the nozzle opening 164 of the nozzle 160 is positioned below the heating unit 50. The heating unit 50 is positioned above the nozzle opening 164 of the nozzle 160 when the three-dimensional shaped object is shaped. Although not shown, the nozzle opening 164 may be positioned above the heating unit 50 when the three-dimensional shaped object is not being shaped. In the shown example, two through holes 52 are formed corresponding to the two dispensing units 10.

The heating unit 50 includes, for example, a plate 54, a heater 56, and a heat insulating member 58.

The plate 54 faces the shaping surface 22. The plate 54 is provided between the shaping surface 22 and the heater 56. A material of the plate 54 is, for example, aluminum.

The heater 56 is provided on the plate 54. The heater 56 is provided between the plate 54 and the heat insulating member 58. A shape of the heater 56 is, for example, a plate shape. As the heater 56, for example, a rubber heater is used. The heater 56 heats the shaping layers stacked on the shaping surface 22 via the plate 54. An output of the heater 56 is controlled by the control unit 60.

The heat insulating member 58 is provided on the heater 56. The heat insulating member 58 is coupled to, for example, the support unit 40. As the heat insulating member 58, for example, a loss rim board (registered trademark) is used. The heat insulating member 58 can reduce heat of the heater 56 transferred above the heat insulating member 58.

For example, the control unit 60 is implemented by a computer including a processor, a main storage device, and an input and output interface that receives and outputs a signal from and to the outside. The control unit 60 exerts various functions by, for example, executing, by the processor, a program read into the main storage device. Specifically, the control unit 60 controls the dispensing unit 10, the position changing unit 30, and the heating unit 50. The control unit 60 may be implemented by a combination of a plurality of circuits instead of the computer.

### 1.2. Stage

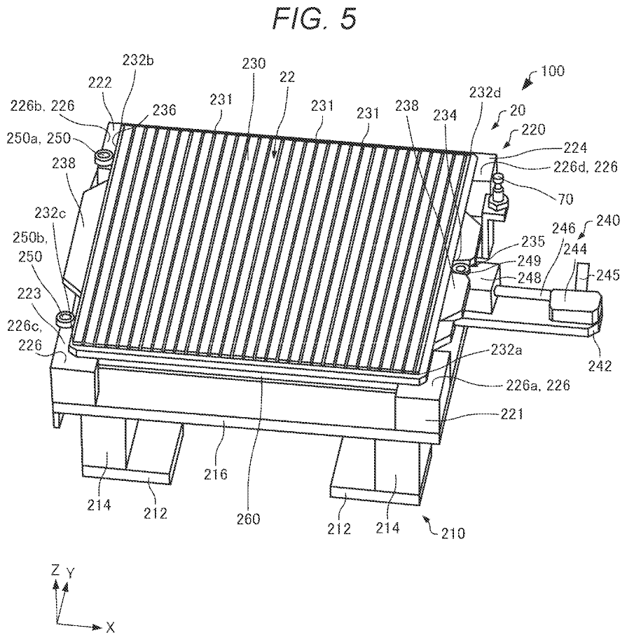

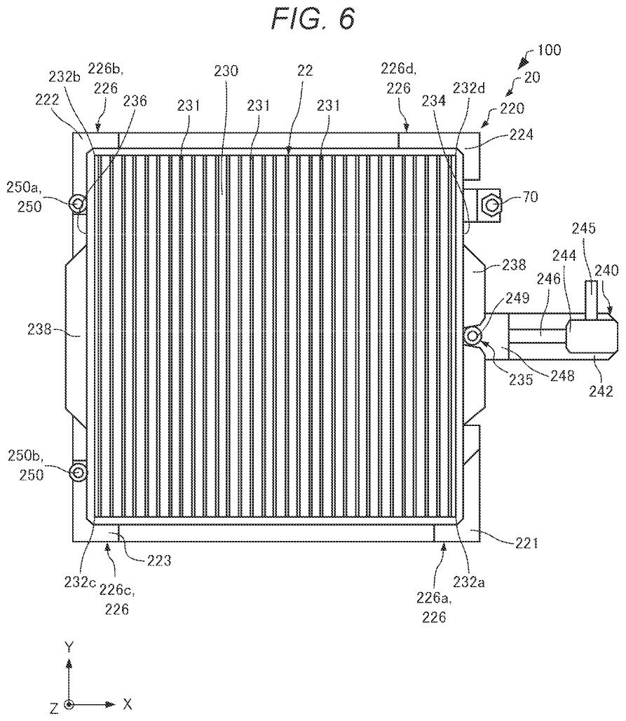

FIG. 5 is a perspective view schematically showing the stage 20 of the three-dimensional shaping device 100. FIG. 6 is a plan view schematically showing the stage 20 of the three-dimensional shaping device 100. As shown in FIGS. 5 and 6, the stage 20 includes, for example, a support table 210, a placement portion 220, a shaping stage 230, a pressing member 240, retaining members 250, and a heating unit 260. The stage 20 is a three-dimensional shaping stage on which the three-dimensional shaped object is placed.

As shown in FIG. 5, the support table 210 supports the placement portion 220. The support table 210 includes, for example, first plate members 212, columns 214, and a second plate member 216.

Two first plate members 212 of the support table 210 are provided. The two first plate members 212 are separated from each other. The first plate members 212 are fixed to the position changing unit 30. The column 214 is provided on the first plate member 212. The columns 214 support the second plate member 216. The column 214 has, for example, a rectangular shape in which a size of the column 214 in the Y-axis direction is larger than those in the X-axis direction and the Z-axis direction. The second plate member 216 is provided on the columns 214. The second plate member 216 is provided across the two columns 214.

The placement portion 220 is provided on the second plate member 216. The placement portion 220 is provided between the second plate member 216 and the shaping stage 230. In the shown example, the placement portion 220 is implemented by a first placement member 221, a second placement member 222, a third placement member 223, and a fourth placement member 224. Each of the placement members 221, 222, 223, and 224 is provided at four corners of the second plate member 216. The placement members 221, 222, 223, and 224 are separated from each other. In the shown example, the second placement member 222 is provided on a diagonal line with respect to the first placement member 221. The third placement member 223 is provided in the −X-axis direction of the first placement member 221 and in the −Y-axis direction of the second placement member 222. The fourth placement member 224 is provided in the +Y-axis direction of the first placement member 221 and in the +X-axis direction of the second placement member 222. Shapes of the placement members 221, 222, 223, and 224 are, for example, rectangular bodies.

Although not shown, the placement portion 220 may be implemented by one placement member formed by the continuous placement members 221, 222, 223, and 224, or may be implemented by two placement members formed by the continuous placement members 221 and 224 and the continuous placement members 222 and 223.

The placement portion 220 has a reference surface 226 whose flatness is adjusted. In the shown example, the placement portion 220 has a plurality of reference surfaces 226. The reference surfaces 226 are upper surfaces of the placement members 221, 222, 223, and 224. In the shown example, the placement portion 220 includes a first reference surface 226a, a second reference surface 226b, a third reference surface 226c, and a fourth reference surface 226d as the reference surfaces 226. The first reference surface 226a is the upper surface of the first placement member 221. The second reference surface 226b is the upper surface of the second placement member 222. The third reference surface 226c is the upper surface of the third placement member 223. The fourth reference surface 226d is the upper surface of the fourth placement member 224.

A height of the reference surface 226 of the placement portion 220 in the Z-axis direction is adjusted. For example, the flatness of the reference surface 226 is adjusted by adjusting a tolerance of the position changing unit 30 in the Z-axis direction, a tolerance of the support table 210 in the Z-axis direction, and a tolerance of the placement portion 220 in the Z-axis direction. The flatness of reference surface 226 is, for example, 100 μm or less, and preferably 50 μm or less. The flatness is measured in accordance with, for example, “JIS0621-1984”.

The shaping stage 230 is placed on the reference surface 226 of the placement portion 220. The shaping stage 230 is in contact with the reference surface 226. A shape of the shaping stage 230 is a plate shape. The shaping stage 230 has a substantially rectangular shape when viewed from the Z-axis direction. The Z-axis direction is a direction perpendicular to the shaping surface 22. The placement portion 220 supports four corners of the shaping stage 230. A material of the shaping stage 230 is, for example, aluminum. The position changing unit 30 changes relative positions of the heating unit 50 and the shaping stage 230 within a range in which at least a part of the heating unit 50 and at least a part of the shaping stage 230 overlap in the Z-axis direction.

The shaping stage 230 has the shaping surface 22, a first side surface 234, and a second side surface 236.

Shaping layers made of the shaping material dispensed from the nozzle 160 are stacked on the shaping surface 22. A shape of the shaping surface 22 is, for example, a square when viewed from the Z-axis direction. The shaping surface 22 is provided between the first side surface 234 and the second side surface 236. A plurality of grooves 231 are formed in the shaping surface 22. In the shown example, the grooves 231 extend in the Y-axis direction. The plurality of grooves 231 are arranged in the X-axis direction. The plurality of grooves 231 can improve adhesion between the shaping stage 230 and the shaping layers stacked on the shaping surface 22. The grooves 231 may not be formed.

The shaping surface 22 includes a first corner portion 232a, a second corner portion 232b, a third corner portion 232c, and a fourth corner portion 232d when viewed from the Z-axis direction. When viewed from the Z-axis direction, the first corner portion 232a overlaps the first reference surface 226a. The second corner portion 232b overlaps the second reference surface 226b. The third corner portion 232c overlaps the third reference surface 226c. The fourth corner portion 232d overlaps the fourth reference surface 226d.

The first side surface 234 is provided, for example, in the +X-axis direction of the shaping surface 22. The second side surface 236 is provided, for example, in the −X-axis direction of the shaping surface 22. The second side surface 236 is a side surface opposite to the first side surface 234. The first side surface 234 and the second side surface 236 constitute a handle 238 for a user to grip the shaping stage 230.

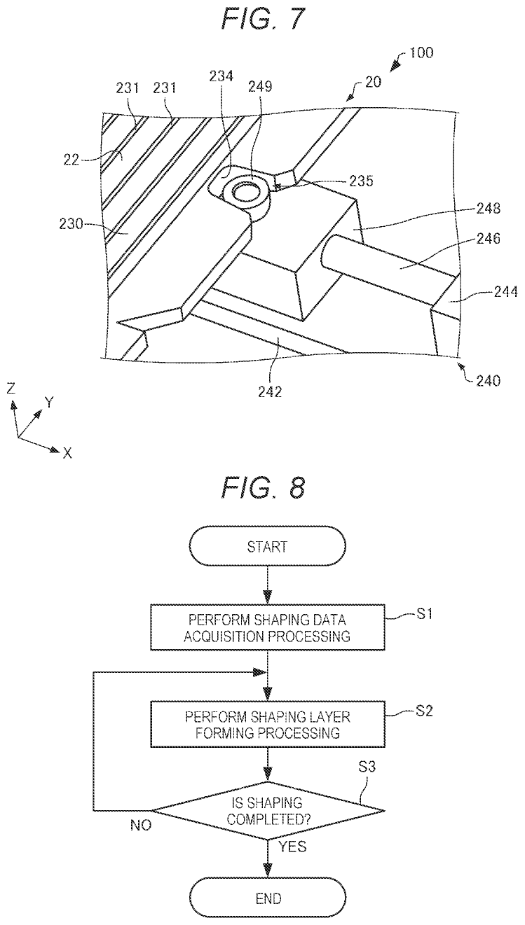

A recessed portion 235 is formed in the first side surface 234. Here, FIG. 7 is a perspective view schematically showing the vicinity of the recessed portion 235 of the stage 20. For convenience, members other than the shaping stage 230 and the pressing member 240 are not shown in FIG. 7.

As shown in FIGS. 5 to 7, the recessed portion 235 is formed in, for example, the handle 238 of the first side surface 234. The recessed portion 235 penetrates the handle 238 in the Z-axis direction. The recessed portion 235 has a tapered shape in which a width of the recessed portion 235 decreases toward the shaping surface 22 when viewed from the Z-axis direction. In the shown example, the recessed portion 235 has a tapered shape in which a width of the recessed portion 235 decreases toward the −X-axis direction.

The pressing member 240 is provided, for example, in the +X-axis direction of the shaping stage 230. The pressing member 240 presses the shaping stage 230 against the retaining member 250 in a direction along the shaping surface 22. In the shown example, the pressing member 240 presses the shaping stage 230 against the retaining member 250 in the −X-axis direction. The pressing member 240 biases the shaping stage 230 toward the retaining member 250.

The pressing member 240 includes, for example, a base unit 242, a fixing portion 244, a gripping portion 245, a spring 246, and a contact portion 248. A shape of the base unit 242 is, for example, a plate shape. The fixing portion 244 is fixed on the base unit 242. The gripping portion 245 is coupled to the fixing portion 244. In the shown example, the gripping portion 245 extends from the fixing portion 244 in the +Y-axis direction. The gripping portion 245 is a portion to be gripped by the user. The spring 246 is fixed to the fixing portion 244. The spring 246 biases the contact portion 248 toward the shaping stage 230. Accordingly, the pressing member 240 biases the shaping stage 230 toward the retaining member 250.

The contact portion 248 of the pressing member 240 is provided on the base unit 242. The contact portion 248 is in contact with the shaping stage 230. The contact portion 248 includes an engaging member 249 that engages with the recessed portion 235. The engaging member 249 enters the recessed portion 235. A shape of the engaging member 249 is, for example, a cylindrical shape. The shape of the engaging member 249 is not particularly limited as long as the engaging member 249 can engage with the recessed portion 235.

The retaining member 250 is provided, for example, in the −X-axis direction of the shaping stage 230. A shape of the retaining member 250 is, for example, a cylindrical shape. The retaining member 250 is in contact with the second side surface 236. The retaining member 250 retains the shaping stage 230 pressed by the pressing member 240 on the second side surface 236. The shape of the retaining member 250 is not particularly limited as long as the retaining member 250 can retain the shaping stage 230.

For example, a plurality of retaining members 250 are provided. In the shown example, the stage 20 includes a first retaining member 250a and a second retaining member 250b as the retaining members 250. The first retaining member 250a and the second retaining member 250b are separated from each other. In the shown example, the handle 238 is provided between the first retaining member 250a and the second retaining member 250b. When viewed from the −X-axis direction, the recessed portion 235 is positioned between the first retaining member 250a and the second retaining member 250b. The −X-axis direction is a direction in which the pressing member 240 is pressed against the shaping stage 230.

As shown in FIG. 5, the heating unit 260 is provided between the support table 210 and the shaping stage 230. A shape of the heating unit 260 is a plate shape. The heating unit 260 includes, for example, a rubber heater. The heating unit 260 heats the shaping stage 230. The heating unit 260 may be biased toward the shaping stage 230 by a biasing member (not shown) provided below the heating unit 260. In this case, an axis of the cylindrical retaining member 250 may be inclined with respect to the Z-axis such that the shaping stage 230 is not displaced upward by the biasing member. The contact portion 248 of the pressing member 240 may be inclined with respect to the Z-axis such that the shaping stage 230 is not displaced upward by the biasing member.

As shown in FIGS. 5 and 6, a sensor 70 is fixed to the stage 20. The three-dimensional shaping device 100 includes the sensor 70. The sensor 70 is moved in conjunction with the stage 20 by the position changing unit 30. The sensor 70 is a contact type touch sensor in contact with the heating unit 50. The sensor 70 measures flatness of a lower surface of the heating unit 50 by contacting the lower surface of the heating unit 50. In the shown example, only one sensor 70 is provided.

### 1.3. Operation

FIG. 8 is a flowchart showing an operation of the three-dimensional shaping device 100. Specifically, FIG. 8 is a flowchart showing processing of the control unit 60. For example, the user operates an operation unit (not shown) to output, to the control unit 60, a processing start signal for starting the processing. The operation unit is implemented by, for example, a mouse, a keyboard, and a touch panel. When the processing start signal is received, the control unit 60 starts the processing.

First, as shown in FIG. 8, in step S1, the control unit 60 performs shaping data acquisition processing of acquiring shaping data for shaping a three-dimensional shaped object.

The shaping data includes, for example, information related to a type of the material stored in the material storage unit 110, a movement path of the dispensing unit 10 with respect to the stage 20, an amount of the shaping material dispensed from the dispensing unit 10, or the like.

The shaping data is created by, for example, causing a slicer software installed in a computer connected to the three-dimensional shaping device 100 to read shape data. The shape data is data representing a target shape of the three-dimensional shaped object created using three-dimensional computer aided design (CAD) software, three-dimensional computer graphics (CG) software, or the like. As the shape data, for example, data such as a standard triangulated language (STL) format or an additive manufacturing file format (AMF) is used. The slicer software divides the target shape of the three-dimensional shaped object into layers having a predetermined thickness and creates shaping data for each layer. The shaping data is represented by a G code, an M code, or the like. The control unit 60 acquires shaping data from a recording medium such as a computer or a universal serial bus (USB) memory connected to the three-dimensional shaping device 100.

Next, in step S2, the control unit 60 performs shaping layer forming processing of dispensing a shaping material to the shaping surface 22 of the stage 20 to form a shaping layer.

Specifically, the control unit 60 plasticizes the material supplied between the flat screw 130 and the barrel 140 to generate the shaping material, and dispenses the shaping material from the nozzle 160. For example, the control unit 60 continues to generate the shaping material until the shaping layer forming processing is completed.

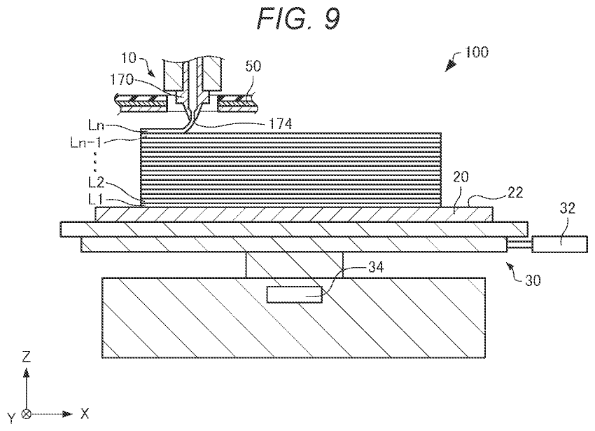

Here, FIG. 9 is a cross-sectional view showing the shaping layer forming processing of the three-dimensional shaping device 100.

As shown in FIG. 9, based on the acquired shaping data, the control unit 60 controls the position changing unit 30 to change the relative positions of the dispensing unit 10 and the stage 20, and controls the dispensing unit 10 to dispense the shaping material from the nozzle 160 toward the stage 20.

Specifically, before the shaping layer forming processing is started, that is, before formation of a shaping layer L1 which is a first shaping layer is started, the nozzle 160 is disposed at an initial position in the −X-axis direction of an end portion of the stage 20 in the −X-axis direction. When the shaping layer forming processing is started, as shown in FIG. 9, the control unit 60 controls the position changing unit 30 to, for example, move the nozzle 160 in the +X-axis direction relative to the stage 20. When the nozzle 160 passes over the stage 20, the shaping material is dispensed from the nozzle 160. Accordingly, the shaping layer L1 is formed. In FIG. 9, n is any natural number, and up to an n-th shaping layer Ln are shown.

Next, as shown in FIG. 8, in step S3, the control unit 60 performs determination processing of determining, based on the shaping data, whether the formation of all the shaping layers is completed.

When it is determined that the formation of all the shaping layers is not completed (“NO” in step S3), the control unit 60 returns the processing to step S2. The control unit 60 repeats steps S2 and S3 until it is determined that the formation of all the shaping layers is completed in step S3.

On the other hand, when it is determined that the formation of all the shaping layers is completed (“YES” in step S3), the control unit 60 ends the processing.

### 1.4. Operation and Effect

The stage 20 includes the placement portion 220 having the reference surface 226 whose flatness is adjusted. The stage 20 further includes the shaping stage 230 which has the shaping surface 22 on which the shaping layers are stacked, the first side surface 234 on which the recessed portion 235 is formed, and the second side surface 236 opposite to the first side surface 234, and which is placed on the reference surface 226. The stage 20 further includes the pressing member 240 which has the engaging member 249 engaging with the recessed portion 235 and which presses the shaping stage 230 in the direction along the shaping surface 22, and the retaining member 250 which retains the shaping stage 230 on the second side surface 236.

Therefore, in the stage 20, when the shaping stage 230 is heated, the engaging member 249 retreats in the X-axis direction due to elasticity of the pressing member 240, and the shaping stage 230 is thermally expanded. Further, the shaping stage 230 is thermally expanded freely around a position of the recessed portion 235 in the Y-axis direction. As described above, in the stage 20, thermal expansion is not blocked even when the shaping stage 230 is heated, and thus distortion is unlikely to occur in the shaping surface 22. Accordingly, the flatness of the shaping surface 22 of the shaping stage 230 can be reduced. That is, the shaping surface 22 can be made more planar. When the flatness of the shaping surface is large, the nozzle may collide with the shaping stage or the shaping layer.

In the stage 20, the retaining member 250 includes the first retaining member 250a and the second retaining member 250b, and the recessed portion 235 is positioned between the first retaining member 250a and the second retaining member 250b when viewed from a pressing direction of the pressing member 240. Therefore, in the stage 20, rotation of the shaping stage 230 caused by pressing the shaping stage 230 with the pressing member 240 can be prevented.

In the stage 20, when viewed from the direction perpendicular to the shaping surface 22, the recessed portion 235 has a tapered shape that decreases toward the shaping surface 22. Therefore, in the stage 20, the shaping stage 230 can be easily disposed at a predetermined position only by engaging the engaging member 249 with the recessed portion 235 and pressing the shaping stage 230 with the pressing member 240. Accordingly, individual differences of users are less likely to occur with respect to the position of the shaping stage 230.

### 2. Modification of Three-Dimensional Shaping Device

### 2.1. First Modification

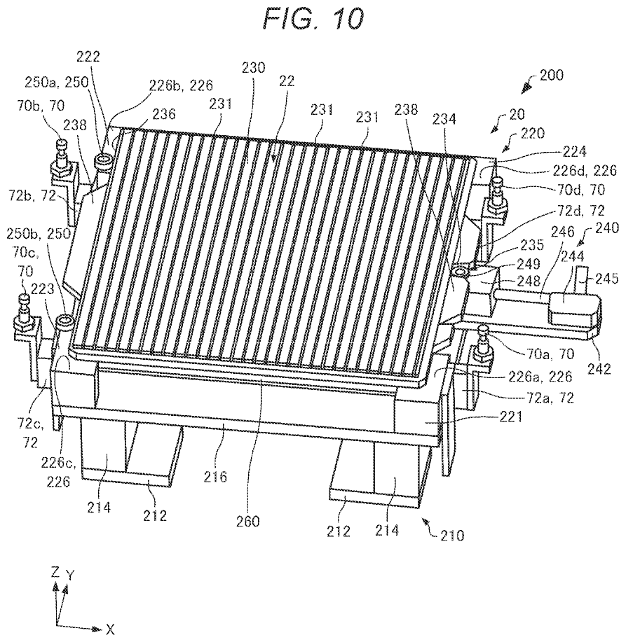

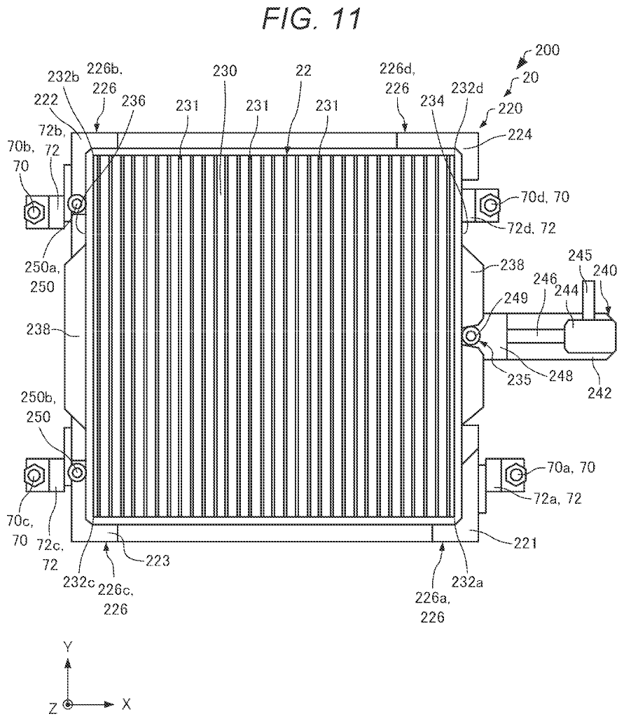

Next, a three-dimensional shaping device according to a first modification of the embodiment will be described with reference to the drawings. FIG. 10 is a perspective view schematically showing a three-dimensional shaping device 200 according to the first modification of the embodiment. FIG. 11 is a plan view schematically showing the three-dimensional shaping device 200 according to the first modification of the embodiment.

Hereinafter, in the three-dimensional shaping device 200 according to the first modification of the embodiment, members having the same functions as constituent members of the three-dimensional shaping device 100 according to the embodiment described above are denoted by the same reference numerals, and detailed description thereof is omitted. This is the same in three-dimensional shaping devices according to second and third modifications of the embodiment to be described later.

The three-dimensional shaping device 100 described above includes one sensor 70 as shown in FIGS. 5 and 6.

In contrast, the three-dimensional shaping device 200 includes a plurality of sensors 70 as shown in FIGS. 10 and 11. The three-dimensional shaping device 200 further includes a plurality of movement mechanisms 72.

The sensors 70 are fixed to a peripheral edge of the placement portion 220 via the movement mechanisms 72. In the shown example, the three-dimensional shaping device 200 includes, as the sensors 70, a first sensor 70a, a second sensor 70b, a third sensor 70c, and a fourth sensor 70d. The three-dimensional shaping device 200 includes, as the movement mechanisms 72, a first movement mechanism 72a, a second movement mechanism 72b, a third movement mechanism 72c, and a fourth movement mechanism 72d.

The first sensor 70a is fixed to the first placement member 221 via the first movement mechanism 72a. The second sensor 70b is fixed to the second placement member 222 via the second movement mechanism 72b. The third sensor 70c is fixed to the third placement member 223 via the third movement mechanism 72c. The fourth sensor 70d is fixed to the fourth placement member 224 via the fourth movement mechanism 72d. The first sensor 70a and the fourth sensor 70d are positioned in the +X-axis direction of the shaping stage 230. The second sensor 70b and the third sensor 70c are positioned in the −X-axis direction of the shaping stage 230.

The movement mechanism 72 moves the sensor 70 in the Z-axis direction. The movement mechanism 72 includes, for example, a motor and a linear guide. The first movement mechanism 72a moves the first sensor 70a in the Z-axis direction. The second movement mechanism 72b moves the second sensor 70b in the Z-axis direction. The third movement mechanism 72c moves the third sensor 70c in the Z-axis direction. The fourth movement mechanism 72d moves the fourth sensor 70d in the Z-axis direction.

The control unit 60 controls the movement mechanisms 72. When the first sensor 70a is in contact with the heating unit 50, the control unit 60 controls the first movement mechanism 72a to position an upper surface of the first sensor 70a above the shaping surface 22, and controls the movement mechanisms 72b, 72c, and 72d to position upper surfaces of the sensors 70b, 70c, and 70d below the shaping surface 22.

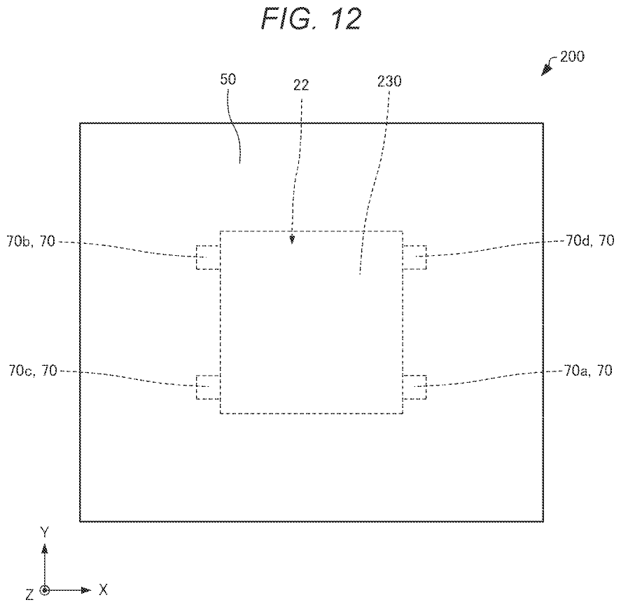

Here, FIG. 12 is a plan view schematically showing the heating unit 50, the sensors 70, and the shaping stage 230. For convenience, in FIG. 12, the heating unit 50, the sensors 70, and the shaping stage 230 are shown in a simplified manner.

When viewed from the Z-axis direction, an area of the heating unit 50 is larger than an area of the shaping stage 230. Therefore, by providing the plurality of sensors 70, it is possible to measure the flatness of the entire surface of the heating unit 50 by the sensors 70 without increasing a movement range of the stage 20 with respect to the heating unit 50 as compared with the case where only one sensor 70 is provided. Accordingly, a reduction in size of the position changing unit 30 can be achieved. Further, when an abnormality occurs in the heating unit 50 due to collision of the heating unit 50 with the shaping layer or the stage 20, flatness of a portion of the heating unit 50 where the abnormality occurs can be measured more quickly than in the case where only one sensor 70 is provided.

The plurality of sensors 70 may measure the same portion of the heating unit 50. The portion is, for example, a center of the heating unit 50 as viewed from the Z-axis direction. The control unit 60 may control the position changing unit 30 and the movement mechanisms 72 to cause the plurality of sensors 70 to measure the same portion of the heating unit 50.

The three-dimensional shaping device 200 includes the first sensor 70a and the second sensor 70b that are fixed to the placement portion 220 and measure the flatness of the heating unit 50. Therefore, in the three-dimensional shaping device 200, the flatness of the heating unit 50 can be measured in a wide range by the first sensor 70a and the second sensor 70b. Further, as described above, a reduction in size of the position changing unit 30 can be achieved. Further, as described above, it is possible to quickly measure the flatness of the portion of the heating unit 50 where the abnormality occurs. When the flatness of the heating unit is large, a temperature distribution of the shaping layer may deteriorate or the heating unit may collide with the shaping layer or the stage.

The three-dimensional shaping device 200 includes the first movement mechanism 72a that moves the first sensor 70a in a direction perpendicular to the shaping surface 22, and the second movement mechanism 72b that moves the second sensor 70b in the direction perpendicular to the shaping surface 22. The sensors 70a and 70b are contact type sensors in contact with the heating unit 50. When the flatness of the heating unit 50 is measured by the first sensor 70a, the control unit 60 controls the first movement mechanism 72a to position the first sensor 70a above the shaping surface 22, and controls the second movement mechanism 72b to position the second sensor 70b below the shaping surface 22. Therefore, in the three-dimensional shaping device 200, the first sensor 70a can be brought into contact with the heating unit 50, and the second sensor 70b can be separated from the heating unit 50. Accordingly, it is possible to prevent measurement information from being simultaneously transmitted from the first sensor and the second sensor and prevent a measurement portion and the measurement information from not being correlated with each other. When the correlation between the measurement portion and the measurement information is obtained, the first sensor 70a and the second sensor 70b may be simultaneously brought into contact with the heating unit 50.

In the three-dimensional shaping device 200, the first sensor 70a and the second sensor 70b measure the same portion of the heating unit 50. Therefore, the three-dimensional shaping device 200 can detect a measurement error between the first sensor 70a and the second sensor 70b.

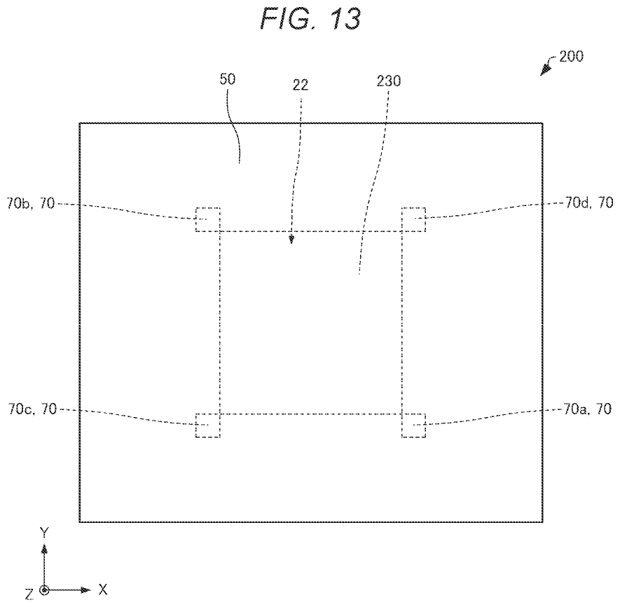

As shown in FIG. 13, the plurality of sensors 70 may be provided at the corners of the placement portion 220. The plurality of sensors 70 may be provided at positions where the plurality of sensors 70 do not overlap the shaping surface 22 when viewed from the X-axis direction and do not overlap the shaping surface 22 when viewed from the Y-axis direction. Accordingly, even when the movement range of the stage 20 with respect to the heating unit 50 is narrowed, the flatness of the entire surface of the heating unit 50 can be measured by the sensors 70.

### 2.2. Second Modification

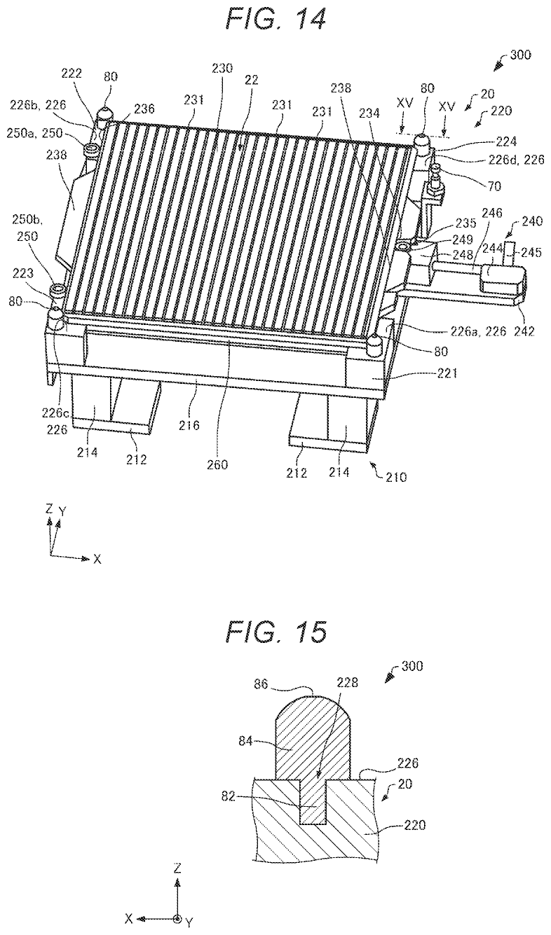

Next, the three-dimensional shaping device according to the second modification of the embodiment will be described with reference to the drawings. FIG. 14 is a perspective view schematically showing a three-dimensional shaping device 300 according to the second modification of the embodiment. FIG. 15 is a cross-sectional view taken along a line XV-XV in FIG. 14 schematically showing the three-dimensional shaping device 300 according to the second modification of the embodiment.

As shown in FIGS. 14 and 15, the three-dimensional shaping device 300 is different from the three-dimensional shaping device 100 described above in that a recessed portion 228 is provided in the reference surface 226.

A plurality of recessed portions 228 are provided corresponding to the plurality of reference surfaces 226. For example, a reference jig 80 in contact with the heating unit 50 is fitted into the recessed portion 228. As shown in FIG. 15, the reference jig 80 includes a protrusion portion 82 inserted into the recessed portion 228 and a head portion 84 provided on the protrusion portion 82. The head portion 84 has, for example, a shape in which the width decreases upward. The head portion 84 has a contact region 86 in contact with the heating unit 50. The contact region 86 is a planar region. In a state in which the reference jig 80 is fitted into the recessed portion 228, the contact region 86 is positioned above the shaping surface 22.

A plurality of reference jigs 80 are provided corresponding to the plurality of recessed portions 228. Parallelism between the shaping surface 22 and the lower surface of the heating unit 50 can be reduced by bringing the plurality of reference jigs 80 into contact with the heating unit 50. That is, the shaping surface 22 and the lower surface of the heating unit 50 can be made close to parallel. The reference jig 80 is removed from the recessed portion 228 when a three-dimensional shaped object is shaped.

In the three-dimensional shaping device 300, the first reference surface 226a and the second reference surface 226b are provided with recessed portions 228 into which the reference jigs 80 are fitted. Therefore, in the three-dimensional shaping device 300, by bringing a member of the three-dimensional shaping device 300 into contact with the reference jig 80, parallelism between the member and the shaping surface 22 can be reduced. Specifically, the parallelism between the shaping surface 22 and the lower surface of the heating unit 50 can be reduced by the reference jig 80. When the parallelism between the shaping surface and the lower surface of the heating unit is large, the heating unit may collide with the stage or the shaping layer.

Although not shown, the reference surface 226 may be provided with a protrusion portion, and the reference jig 80 may be provided with a recessed portion that is fitted to the protrusion portion. A tip end of the protrusion portion provided on the reference surface 226 is positioned below the shaping surface 22.

### 2.3. Third Modification

Next, the three-dimensional shaping device according to the third modification of the embodiment will be described.

In the three-dimensional shaping device 100 described above, the material stored in the material storage unit 110 is an ABS resin.

On the other hand, in the three-dimensional shaping device according to the third modification of the embodiment, the material stored in the material storage unit 110 is a material other than the ABS resin, or a material obtained by adding another component to the ABS resin.

Examples of the material stored in the material storage unit 110 can include various materials such as a thermoplastic material, a metal material, and a ceramic material as main materials. Here, the term “main material” means a material serving as a center that forms a shape of a shaped object shaped by the three-dimensional shaping device, and means a material that accounts for a content of 50 mass % or more in the shaped object. The materials described above include those materials obtained by melting these main materials alone, and those materials obtained by melting the main materials and a part of contained components into a paste shape.

As the thermoplastic material, for example, a thermoplastic resin can be used. Examples of the thermoplastic resin include general-purpose engineering plastics and super engineering plastics.

Examples of the general-purpose engineering plastic include polypropylene (PP), polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate.

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyether ether ketone (PEEK).

In addition to a pigment, a metal, and a ceramic, an additive such as a wax, a flame retardant, an antioxidant, and a heat stabilizer may be mixed into the thermoplastic material. In the plasticizing unit 120, the thermoplastic material is plasticized and converted into a molten state by rotation of the flat screw 130 and heating of the heater 150. The shaping material generated in this manner is deposited from the nozzle 160, and then is cured due to a decrease in temperature. It is desirable that the thermoplastic material is dispensed from the nozzle 160 in a completely molten state by being heated to a glass transition point or higher.

In the plasticizing unit 120, for example, a metal material may be used as a main material instead of the above-described thermoplastic material. In this case, it is desirable that a powder material obtained by powdering the metal material is mixed with a component that melts when the shaping material is generated, and the mixture is fed into the plasticizing unit 120.

Examples of the metal material include a single metal such as magnesium (Mg), iron (Fe), cobalt (Co), chromium (Cr), aluminum (Al), titanium (Ti), copper (Cu), and nickel (Ni), or an alloy containing one or more of these metals, maraging steel, stainless steel, cobalt chromium molybdenum, a titanium alloy, a nickel alloy, an aluminum alloy, a cobalt alloy, and a cobalt chromium alloy.

In the plasticizing unit 120, a ceramic material can be used as the main material instead of the metal material described above. Examples of the ceramic material include an oxide ceramic such as silicon dioxide, titanium dioxide, aluminum oxide, and zirconium oxide, and a non-oxide ceramic such as aluminum nitride.

The powder material of the metal material or the ceramic material stored in the material storage unit 110 may be a mixed material obtained by mixing a plurality of types of powder of the single metal, powder of the alloy, or powder of the ceramic material. The powder material made of the metal material or the ceramic material may be coated with, for example, the thermoplastic resin described above or another thermoplastic resin. In this case, in the plasticizing unit 120, the thermoplastic resin may be melted to exhibit fluidity.

For example, a solvent can be added to the powder material of the metal material or the ceramic material stored in the material storage unit 110. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetate (for example, tetrabutylammonium acetate); and ionic liquids such as butyl carbitol acetate.

In addition, for example, a binder may be added to the powder material of the metal material or the ceramic material stored in the material storage unit 110. Examples of the binder include an acrylic resin, an epoxy resin, a silicone resin, a cellulose-based resin, other synthetic resins, PLA, PA, PPS, PEEK, and other thermoplastic resins.

The above embodiment and modifications are examples, and the present disclosure is not limited thereto. For example, the embodiment and the modifications may be combined as appropriate.

The present disclosure includes substantially the same configuration, for example, a configuration having the same function, method, and result, or a configuration having the same object and effect, as the configuration described in the embodiment. The present disclosure includes a configuration in which a non-essential portion of the configuration described in the embodiment is replaced. The present disclosure includes a configuration capable of achieving the same operation and effect or a configuration capable of achieving the same object as the configuration described in the embodiment. The present disclosure includes a configuration obtained by adding a known technique to the configuration described in the embodiment.

The following contents are derived from the embodiment and modifications described above.

A three-dimensional shaping stage according to an aspect includes:
a placement portion having a reference surface whose flatness is adjusted;
a shaping stage that has a shaping surface on which a shaping layer is stacked, a first side surface on which a recessed portion is formed, and a second side surface opposite to the first side surface, and that is placed on the reference surface;
a pressing member including an engaging member engaging with the recessed portion and configured to press the shaping stage in a direction along the shaping surface; and
a retaining member configured to retain the shaping stage on the second side surface.

According to the three-dimensional shaping stage, the flatness of the shaping surface of the shaping stage can be reduced.

In the three-dimensional shaping stage according to the aspect,
the retaining member may include a first retaining member and a second retaining member, and
the recessed portion may be positioned between the first retaining member and the second retaining member when viewed from a pressing direction of the pressing member.

According to the three-dimensional shaping stage, rotation of the shaping stage caused by pressing the shaping stage by the pressing member can be prevented.

In the three-dimensional shaping stage according to the aspect,
the recessed portion may have a tapered shape that decreases toward the shaping surface when viewed from a direction perpendicular to the shaping surface.

According to the three-dimensional shaping stage, the shaping stage can be easily disposed at a predetermined position.

In the three-dimensional shaping stage according to the aspect,
the placement portion may have a first reference surface and a second reference surface as the reference surface, and
the first reference surface and the second reference surface may be provided with a recessed portion or a protrusion portion into which a reference jig is fitted.

According to the three-dimensional shaping stage, parallelism between the shaping surface and a member in contact with the reference jig can be reduced.

A three-dimensional shaping device according to an aspect includes:
the three-dimensional shaping stage according to the aspect; and
a nozzle configured to dispense a shaping material toward the three-dimensional shaping stage.

The three-dimensional shaping device according to the aspect may include:
a plate-shaped heating unit provided above the shaping stage, positioned above a nozzle opening of the nozzle during shaping of the three-dimensional shaped object, and configured to heat the shaping layer;
a position changing unit configured to change relative positions of the heating unit and the shaping stage in a range in which at least a part of the heating unit and at least a part of the shaping stage overlap in a direction perpendicular to the shaping surface; and
a first sensor and a second sensor fixed to the placement portion, and configured to measure flatness of the heating unit.

According to the three-dimensional shaping device, the flatness of the heating unit can be measured in a wide range by the first sensor and the second sensor.

The three-dimensional shaping device according to the aspect may include:
a first movement mechanism configured to move the first sensor in the direction perpendicular to the shaping surface;
a second movement mechanism configured to move the second sensor in the direction perpendicular to the shaping surface; and
a control unit configured to control the first movement mechanism and the second movement mechanism, in which
the first sensor and the second sensor may be contact type sensors that are in contact with the heating unit, and
when the flatness of the heating unit is measured by the first sensor, the control unit may control the first movement mechanism to position the first sensor above the shaping surface and control the second movement mechanism to position the second sensor below the shaping surface.

According to the three-dimensional shaping device, the first sensor can be brought into contact with the heating unit and the second sensor can be separated from the heating unit.

In the three-dimensional shaping device according to the aspect,
the first sensor and the second sensor may measure the same portion of the heating unit.

The three-dimensional shaping device can detect a measurement error between the first sensor and the second sensor.

What is claimed is:

1. A three-dimensional shaping stage, comprising:
a placement portion having a reference surface whose flatness is adjusted;
a shaping stage that has a shaping surface on which a shaping layer is stacked, a first side surface on which a recessed portion is formed, and a second side surface opposite to the first side surface, and that is placed on the reference surface;
a pressing member including an engaging member engaging with the recessed portion and configured to press the shaping stage in a direction along the shaping surface; and
a retaining member configured to retain the shaping stage on the second side surface.

2. The three-dimensional shaping stage according to claim 1, wherein
the retaining member includes a first retaining member and a second retaining member, and
the recessed portion is positioned between the first retaining member and the second retaining member when viewed from a pressing direction of the pressing member.

3. The three-dimensional shaping stage according to claim 1, wherein
the recessed portion has a tapered shape that decreases toward the shaping surface when viewed from a direction perpendicular to the shaping surface.

4. The three-dimensional shaping stage according to claim 1, wherein
the placement portion has a first reference surface and a second reference surface as the reference surface, and
the first reference surface and the second reference surface are provided with a recessed portion or a protrusion portion into which a reference jig is fitted.

5. A three-dimensional shaping device, comprising:
the three-dimensional shaping stage according to claim 1; and
a nozzle configured to dispense a shaping material toward the three-dimensional shaping stage.

6. The three-dimensional shaping device according to claim 5, further comprising:
a plate-shaped heating unit provided above the shaping stage, positioned above a nozzle opening of the nozzle during shaping of the three-dimensional shaped object, and configured to heat the shaping layer;
a position changing unit configured to change relative positions of the heating unit and the shaping stage in a range in which at least a part of the heating unit and at least a part of the shaping stage overlap in a direction perpendicular to the shaping surface; and
a first sensor and a second sensor fixed to the placement portion, and configured to measure flatness of the heating unit.

7. The three-dimensional shaping device according to claim 6, further comprising:
a first movement mechanism configured to move the first sensor in the direction perpendicular to the shaping surface;
a second movement mechanism configured to move the second sensor in the direction perpendicular to the shaping surface; and
a control unit configured to control the first movement mechanism and the second movement mechanism, wherein
the first sensor and the second sensor are contact type sensors that are in contact with the heating unit, and
when the flatness of the heating unit is measured by the first sensor, the control unit controls the first movement mechanism to position the first sensor above the shaping surface and controls the second movement mechanism to position the second sensor below the shaping surface.

8. The three-dimensional shaping device according to claim 6, wherein
the first sensor and the second sensor measure the same portion of the heating unit.
